(19) United States
(12) Patent Application Publication
(10) Pub. No.: US 2026/0348779 A1
(43) Pub. Date: Nov. 5, 2026

(54) ESTIMATING A CLAMPING FORCE APPLIED TO A BOLTED JOINT BY ESTIMATING A RESONANT FREQUENCY

(71) Applicant: ATLAS COPCO INDUSTRIAL TECHNIQUE AB, Stockholm (SE)

(72) Inventors: Elvira TROILLET, Stockholm (SE); Malin DYBERG, Tyresö (SE)

(73) Assignee: ATLAS COPCO INDUSTRIAL TECHNIQUE AB, Stockholm (SE)

(21) Appl. No.: 19/487,113

(22) PCT Filed: May 6, 2024
(86) PCT No.: PCT/EP2024/062384

§ 371 Date: Nov. 24, 2025

(30) Foreign Application Priority Data
Jun. 1, 2023 (SE) 2330247-4

(51) Int. Cl. G01L 1/25; B23P 19/06; G01H 1/14; G01H 13/00; G01L 1/10

(52) U.S. Cl. CPC G01L 1/255; B23P 19/06; G01H 1/14; G01H 13/00; G01L 1/10; B23P 2700/11

(57) ABSTRACT

A method of estimating a clamping force applied to a bolted joint is provided. The method comprises receiving a signal representing a vibration excited by impacting the bolted joint; estimating at least one resonant frequency of the bolted joint based on a derivative of a representation of said signal in a frequency domain; and estimating the clamping force applied to the bolted joint based on the estimated at least one resonant frequency. Accordingly, analysis of the vibration signal for identifying the resonant frequencies is facilitated.

### CROSS-REFERENCE TO RELATED APPLICATIONS

This application is a national stage application (filed under 35 U.S.C. § 371) of PCT/EP2024/062384, filed May 6, 2024, of the same title, which in turn claims priority to Swedish Patent App. No. 2330247-4, filed on Jun. 1, 2023; the contents of each of which are hereby incorporated herein by reference.

### FIELD OF THE INVENTION

The present invention generally relates to the field of estimating a clamping force applied to a bolted joint.

### BACKGROUND OF THE INVENTION

An important task in the field of tightening technique is to achieve a desired clamping force in a bolted joint, as this is crucial for the assembly quality. Today's methods for tightening control rely on measuring torque and angle. However, the characteristics of the joint (e.g. the friction in the joint) may affect the amount of torque required to achieve a certain clamping force. This may result in a clamping force installed in the joint that may deviate from a desired value since the tightening was conducted based on the measured torque and angle and not the actual clamping force. Research on additional methods is being conducted in order to further increase the confidence in the assembly quality.

Such research has shown that the natural frequencies in a bolted joint are related to the clamping force applied to bolted joint. By impacting the bolted joint, e.g. with a hammer, a vibration in the bolted joint is excited. This vibration can be registered with an accelerometer applied on the bolted joint or a microphone picking up the resulting sound. The vibration signal can then be analyzed so as to identify the natural frequencies, which are then correlated with a clamping force. An example of such a method of estimating a clamping force is disclosed in JP2002340710A.

A challenge in estimating the clamping force in this manner is that the vibration signal is often difficult to interpret and it may be hard to actually identify the natural frequencies of the bolted joint in the signal.

### SUMMARY OF THE INVENTION

It would be advantageous to achieve a method and a control device overcoming, or at least alleviating, the above-mentioned drawbacks. In particular, it would be desirable to enable a method and a control device facilitating estimating a clamping force. It would also be desirable to provide a method and a control device that enables achieving an increased accuracy of an installed clamping force.

To better address one or more of these concerns, a method and a control device having the features defined in the independent claims are provided. Preferable embodiments are defined in the dependent claims.

Hence, according to a first aspect, a method of estimating a clamping force applied to a bolted joint is provided. The method comprises receiving a signal representing a vibration excited by impacting the bolted joint; estimating at least one resonant frequency of the bolted joint based on a derivative of a representation of said signal in a frequency domain; and estimating the clamping force applied to the bolted joint based on the estimated at least one resonant frequency.

The natural frequencies of a physical system can be determined through frequency analysis by measuring the vibrations that occur when applying an external force. Signals in the time domain can be observed as frequencies in the frequency domain using frequency analysis. The natural frequencies of a structure are inherent properties that depend on the distribution of mass and stiffness within the structure. When excited by an impact force, the structure will tend to vibrate at its natural frequencies. This is because an impact force is composed of a spectrum of frequencies, some of which are equal to the natural frequencies of the structure. These frequencies are called resonant frequencies, and will cause the structure to vibrate at higher amplitudes. This phenomenon is called resonance, and can be detected by measuring the vibrations of the structure and transforming the resulting data to the frequency domain, since the large vibration response at the resonant frequencies may appear as peaks in the frequency response. Depending on the damping of the system, the measurable resonant frequencies can appear somewhat different from the actual natural frequencies. However, it has been found that the damping properties of a bolted joint are low enough for the resonant frequencies to be considered as accurate measurements of the undamped natural frequencies.

Now, the inventors have realized that analysis of the derivative (such as a curve of the derivative) of the vibration signal in the frequency domain can be made in order to identify the one or more resonant frequencies (essentially corresponding to the natural frequencies of the bolted joint) in a more reliable way. The inventors have found that distinctive peaks (positive or negative) in this derivative appear at the resonant frequencies. The representation of the vibration signal in the frequency domain may comprise many peaks which are not at all related to the resonant frequencies of the bolted joint. For example, frequencies originating from the device impacting the joint and from the work piece in which the joint is installed may cause peaks in the vibration signal in the frequency domain. However, the increase/decrease of the derivative resulting from such peaks may not be as distinct (high or low) as the increase/decrease of the derivative resulting from the resonant frequencies. Accordingly, with the present invention, analysis of the vibration signal for identifying the resonant frequencies is facilitated. Further, estimation of the clamping force by estimating the resonant frequencies enables achieving an increased accuracy of the installed clamping force as compared to if torque and angle control is used. Further, a facilitated analysis for estimating the clamping force is beneficial since for example in wind turbines, the clamping force of the bolted joints need to be checked as often as twice a year for security reasons. Facilitating the analysis in such procedure may saving time, which in turn may save costs.

A bolted joint has (in similarity with most other structures) multiple natural frequencies, which correspond to different modes of vibration. Corresponding multiple resonant frequencies may therefore be represented in the collected vibration signal. It may suffice to estimate/identify at least one of these resonant frequencies for estimating the clamping force. Typically, the first resonant frequency may be the most distinguished one in the vibration signal and therefore the easiest one to detect.

The method may comprise transforming the vibration signal from a time domain to a frequency domain. Thereby, the representation of the signal in the frequency domain is provided. This may be done using any suitable time-frequency analysis technique.

For example, the method may comprise applying a Fourier transform (FT) on the received signal for transforming it from a time domain to the frequency domain. For example, a discrete Fourier transform (DFT) may be applied on the signal. Optionally, a fast Fourier transform (FFT) may be used to compute the DFT, which has the benefit of being efficient in terms of computing power. Different types of FT: s are, in themselves, well known in the art and will not be described further herein.

According to an embodiment, the derivative of the representation of the signal in the frequency domain may be a derivative of the Fourier transform of the signal. Hence, the Fourier transform of the vibration signal may itself be differentiated and further analysed in order to identify the at least one resonant frequency.

According to an embodiment, the method may further comprise deriving a power spectral density (PSD) from the received signal, wherein the derivative of the representation of the signal in the frequency domain is a derivative of the power spectral density of the signal.

For example, the PSD may be derived from (i.e. be based on) the Fourier transform of the signal.

PSD is a measure of the power distribution of a signal over its frequency spectrum and can therefore be seen as a representation of the signal in the frequency domain. It can be seen as providing a description of the power of a signal at different frequencies. PSD may e.g. be calculated using the Fourier transform of the signal (other methods of calculating the PSD may also be envisaged). The squared magnitude of the Fourier transform of a signal may represent the power of the signal at each frequency. PSD may be obtained by averaging the squared magnitude of the Fourier transform over a given time period or over a large number of realizations of the signal.

With the present embodiment, the PSD may be differentiated and further analysed (as an alternative or complement to differentiating the FT of the signal directly). The inventors have realized that the derivative of the PSD gives a clear indication of the resonant frequencies in the signal and may therefore be beneficial to use as a basis for estimating the one or more resonant frequencies.

According to an embodiment, estimating the at least one resonant frequency of the bolted joint may comprise identifying a peak value of the derivative (of the representation of the signal in the frequency domain).

In the context of the present specification, the term “peak value” may include both a positive peak value and a negative peak value. In other words, the method may comprise identifying an extreme value (e.g. a maximum or minimum value) of the derivative. For example, a maximum absolute value of the derivative may be identified. The inventors have found that the peak value of the derivative may mark/signify the one or more resonant frequency present in the vibration signal.

Further, a frequency associated with that peak value may be estimated as the resonant frequency of the bolted joint.

For example, the exact frequency associated with the maximum absolute value of the derivative may be estimated as the resonant frequency. This frequency may not be exactly equal to the actual resonant frequency but can be a good enough approximation thereof, and may require a reduced computing capacity to identify. Alternatively (or as a complement), an average of the sum of the frequency at the maximum positive value of the derivative and the frequency at the maximum negative value of the derivative may be estimated as the resonant frequency. This may be a more precise approximation of the exact resonant frequency. Alternatively (or as a complement), the frequency of the zero crossing between the maximum positive value of the derivative and the maximum negative value of the derivative may be estimated as the resonant frequency. This may be an even more precise approximation of the resonant frequency.

According to an embodiment, the impact may be generated by a tightening tool, which is the tightening tool applying the clamping force to the bolted joint, or by a device external to such tightening tool, such as a pendulum or a hammer (e.g. an impact hammer).

For example, the tightening tool may be arranged to deliver a tightening torque in a pulsed manner, and wherein the impact is one of the torque pulses generated by the tool. For example, the method may be applied on each one of several pulses generated by the tool, such as on every n:th pulse or on one pulse every n:th degree of the tightening angle. The tightening tool may e.g. be a pulse tool (with a pulse unit or pulses generated with an electrical motor) or an impact tool. The present embodiment is advantageous in that no extra device is needed for generating the impacts.

According to an embodiment, the signal may represent a vibration excited by impacting the bolted joint several times without changing the clamping force applied to the bolted joint, which is advantageous in that it may provide a more accurate estimation of the at least one resonant frequency. For example, peak values of the derivative may be identified for each impact. An average or median value of the frequencies of those peak values may be estimated as the resonant frequency.

According to an embodiment, the estimated clamping force may be derived from a look-up table or a function correlating resonant frequency with clamping force. Such look-up table or function may be derived from a structural simulation of the bolted joint, e.g. by using the finite element method (FEM), or from empirical tests.

According to an embodiment, the method may further comprise filtering the received signal based on at least one expected resonant frequency of the bolted joint. For example, this may comprise filtering away frequencies outside a predetermined range, in which the at least one resonant frequency is expected to be found. This may reduce the required computing power.

According to an embodiment, the method may be performed during a tightening operation performed by a tightening tool, such as at least during an end phase of the tightening operation. The present embodiment is advantageous in that it enables tightening operations controlled based on an estimation of the actual clamping force instead of based on e.g. torque and angle, which improves the accuracy of the installed clamping force. Further, the inventors have found that the accuracy of the estimation of the clamping force based on the resonant frequencies increases towards the end of the tightening operation and it may therefore be beneficial to measure an estimated clamping force at least towards the end of the tightening operation, such as during the torque build-up phase (following the rundown and snug phases).

According to an embodiment, the signal representing the vibration may be received from a sensor arranged to sense changes in velocity of the bolted joint, such as an accelerometer. Such sensor may e.g. be applied directly on the fastener of the bolted joint or on the work piece close to the bolted joint. Alternatively, the signal representing the vibration may be received from a sensor arranged to sense changes in air pressure, such as a microphone, which is advantageous in that it may be easier to realize since such sensor may be arranged at/in the tightening tool performing the tightening operation.

According to a second aspect, a control device is provided. The control device may be configured to perform the method according to the first aspect or any one of its' embodiments.

According to an embodiment, a system is provided. The system may comprise a tightening tool adapted to apply said clamping force to the bolted joint, and a control device according to the second aspect.

According to an embodiment, a computer program is provided that comprises instructions which, when the program is executed by a computer (such as the control device), cause the computer to carry out the method according to the first aspect or any one of its' embodiments.

According to an embodiment, a computer-readable storage medium is provided that comprises instructions which, when executed by a computer (such as the control device), cause the computer to carry out the method according to the first aspect or any one of its' embodiments.

It is noted that embodiments of the invention relates to all possible combinations of features recited in the claims. Further, it will be appreciated that the various embodiments described for the method are all combinable with the device as defined in accordance with the second aspect of the present invention.

### BRIEF DESCRIPTION OF THE DRAWINGS

These and other aspects will now be described in more detail in the following illustrative and non-limiting detailed description of embodiments, with reference to the appended drawings.

FIG. 1 shows a system comprising a tightening tool and a control device according to an embodiment.

FIG. 2 shows a method according to an embodiment.

FIG. 3 shows a graph over a PSD of a vibration signal and its derivative according to an embodiment, wherein the vibration signal is generated by impacting a bolted joint.

FIG. 4 shows a magnification of a peak value of the derivative.

Some of the figures are schematic, not necessarily to scale, and generally only show parts which are necessary in order to elucidate the embodiments, wherein other parts may be omitted. Like reference numerals refer to like elements throughout the description.

### DETAILED DESCRIPTION OF EMBODIMENTS

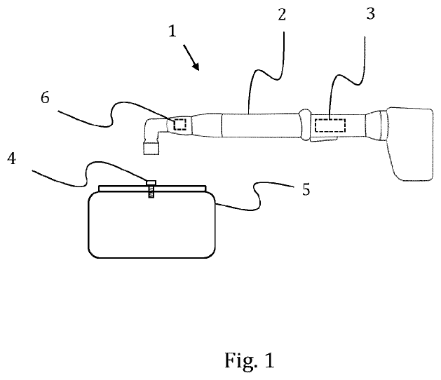

A system 1 according to an embodiment will be described with reference to FIG. 1. The system 1 comprise a tightening tool 2 and a control device 3. The tightening tool 2 may be arranged to tighten bolted joints 4 in a work piece 5, e.g. during an industrial assembly process. The tool 2 may comprise standard components, such as a motor, transmission and a battery. For example, the tool 2 may be a pulse tool or an impact tool. The control device 3 may be arranged inside the tool 2 (as illustrated in FIG. 1) or as separate device external to the tool 2. The control device 3 may be a single unit or distributed in several units (such as cloud based). The control device 3 may comprise processing circuitry and a memory. The control device 3 may optionally be arranged to control tightening operations of the tool 2. Alternatively, it may be separate from a tightening operation control device of the tool 2.

The system 1 may comprise a sensor arranged to sense a vibration excited by impacting the bolted joint 4. Such sensor may e.g. be an accelerometer or a microphone 6. In the latter case, the microphone 6 may e.g. be arranged in/at the tool 2. In case an accelerometer is used, it may be applied to the bolted joint 4 or in the vicinity thereof on the work piece 5.

The bolted joint 4 may e.g. comprise a fastener, either paired with a nut or threaded into a hole in the work piece 5, for clamping at least two pieces of material together. As the tool 2 tightens the bolted joint 4, a clamping force arises in the joint 4 that clamps the at least two pieces of material together. In industrial assembly, it is desirable to apply such clamping force with a high degree of accuracy so that the final clamping force installed in the joint 4 is as close as possible to a prescribed value, which e.g. may be defined in a work specification for the assembly in which the bolted joint is comprised.

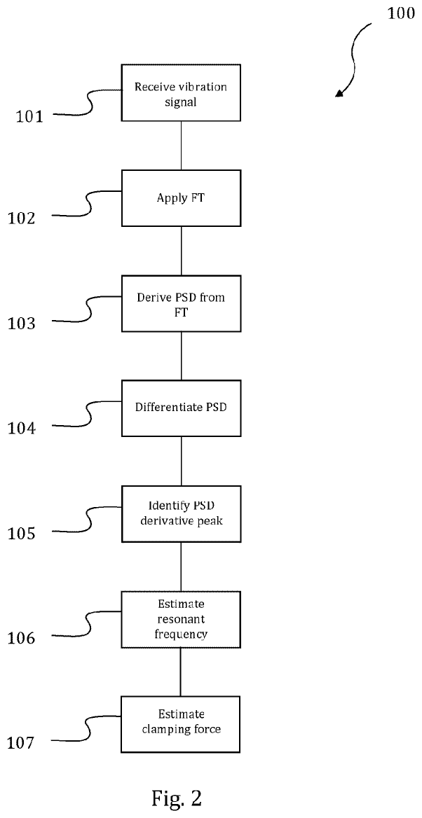

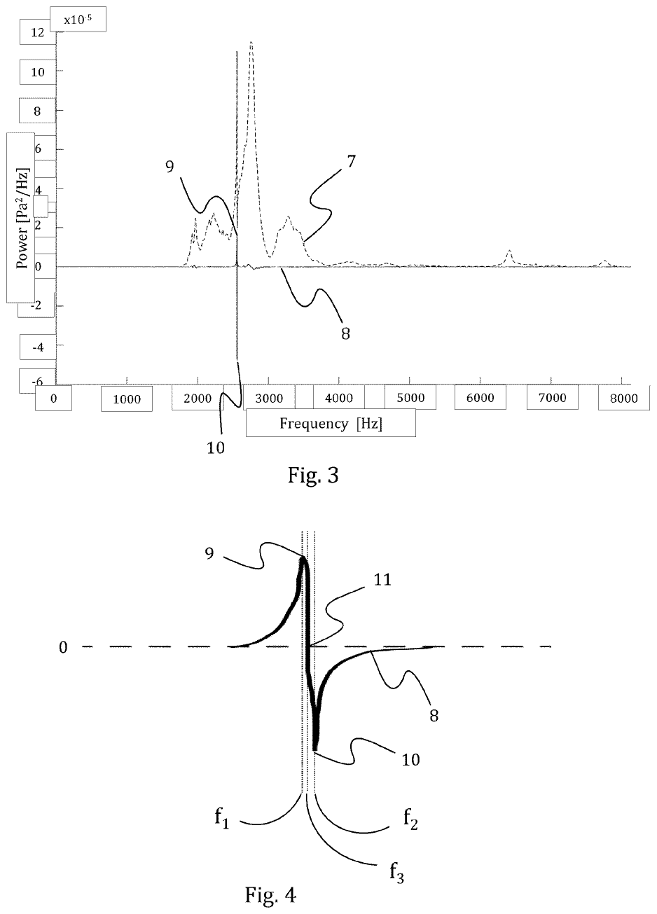

In the following, a method 100 of estimating such a clamping force in a bolted joint according to an embodiment will be described. Reference will be made both to FIG. 2 illustrating a flow chart of an example of the method 100, FIG. 3 showing a graph of a vibration signal and FIG. 4 showing an illustrative magnification of a portion of the graph in FIG. 3.

Firstly, the bolted joint is impacted, either by an external device, such as a hammer, or by the tool itself. In the latter case, the pulses generated by the tool for applying a torque to the bolted joint may generate impacts to the bolted joint.

The impact will cause the bolted joint (and its surrounding structure) to vibrate. This vibration may be detected/recorded by the sensor and may thus result in a signal indicative of the vibration excited by the impact. This vibration signal is received 101 (from the sensor) by the control device. This signal may typically be provided from the sensor in a time domain. In that case, the method 100 may comprise transforming 102 the vibration signal from the time domain to a frequency domain, e.g. by applying a Fourier transform, FT (or any other suitable time-frequency analysis technique). After the transformation, the vibration signal is represented in the frequency domain. In case the signal is provided by a microphone, it may be expressed e.g. in Pascal (per Hz), and in case the signal is provided by an accelerometer it may be expressed in m/s² (per Hz).

Preferably, the method 100 may further comprise deriving 103 a power spectrum density, PSD, of the vibration signal, e.g. from the FT of the signal. An example of such a PSD, based on a real signal collected during an experiment, is illustrated in the graph of FIG. 3. The PSD shows the power distribution of the signal 7 (dashed line) in its' frequency spectrum. In the example in FIG. 3, the signal is provided by a microphone, whereby the PSD is expressed in Pa² per Hz. Should the signal instead be provided by an accelerometer, the PSD may be expressed as (m/s²)² per Hz.

The method 100 may further comprise differentiating 104 the vibration signal (in the frequency domain). In case a PSD has been made, the PSD may be differentiated. Alternatively, the FT of the signal may itself be differentiated. The differentiation may result in a curve of the derivative 8 (solid line), such as the one illustrated in FIG. 3.

As can be seen in FIG. 3, the vibration signal 7 comprises many different frequencies that may result in different peaks in the representation of the signal 7 in the frequency domain. These frequencies may e.g. arise from the device applying the impact and/or from the structure surrounding the bolted joint. This may make it difficult to analyze the vibration signal 7 in itself in order to identify any resonant frequency of the bolted joint. However, as can be seen in FIG. 3, one or more distinctive peaks/spikes, such as one positive peak 9 and one negative peak 10, are clearly distinguishable in the derivative 8 of the signal. The inventors have found that such peaks 9, 10 appear as a result of one of the resonant frequencies present in the vibration signal 7.

Therefore, the method 100 may further comprise to identify 105 one or both of such peaks 9, 10 in the derivative 8.

FIG. 4 shows a magnification of the derivative curve 8 around such peaks 9, 10, the magnification being in the direction of the frequency axis (x-axis) in order to illustrate how the derivative curve 8 oscillates here (the magnification in FIG. 4 is just a schematic illustration and not an exact rendering of the derivative of the signal illustrated in FIG. 3). As can be seen, the derivative 8 may first rapidly increase to a maximum value 9, then rapidly decrease to a minimum value 10 and then back towards zero.

So, in order to identify such a peak 9, 10, the method 100 may e.g. comprise identifying a maximum absolute value of the derivative 8. In this particular case, that would correspond to the absolute value of negative peak 10 of the derivative 10. Alternatively, or as a complement, the method 100 may comprise identifying an extreme value (positive or negative) of the derivative 8.

As a next step, the method 100 may comprise estimating 106 a resonant frequency of the bolted joint based on the derivative 8 of the vibration signal. This may e.g. be made by identifying a frequency associated with the one or more peak values 9, 10 of the derivative 8. For example, the exact frequency of the maximum absolute value may be estimated as the resonant frequency. In the example illustrated in FIGS. 3 and 4, that would correspond to the frequency f₂ of the negative peak 10. This frequency f₂ may not be exactly equal to the actual resonant frequency but can be a good enough approximation thereof. Alternatively (or as a complement), an average of the sum of the frequency f₁ at the maximum positive derivative 9 and the frequency f₂ at the maximum negative derivative 10 may be estimated as the resonant frequency. This may be a more precise approximation of the exact resonant frequency. Alternatively (or as a complement), the frequency f₃ of the zero crossing 11 between the maximum positive derivative 9 and the maximum negative derivative 10 may be estimated as the resonant frequency. This may be an even more precise approximation of the resonant frequency.

The method 100 further comprises estimating 107 a clamping force of the bolted joint based on the estimated resonant frequency. This may e.g. be made using a look-up table or a predetermined function correlating resonant frequency and clamping force.

The method 100 may be performed during a tightening operation, wherein the estimated clamping force may be used as a control parameter. Alternatively, the method 100 may be performed after a tightening operation e.g. for checking the clamping force of an already installed bolted joint.

The person skilled in the art realizes that the present invention by no means is limited to the embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A method of estimating a clamping force applied to a bolted joint, the method comprising:
receiving a signal representing a vibration excited by impacting the bolted joint;
estimating at least one resonant frequency of the bolted joint based on a derivative of a representation of said signal in a frequency domain; and
estimating the clamping force applied to the bolted joint based on the estimated at least one resonant frequency.

2. A method according to claim 1, further comprising applying a Fourier transform on the received signal for transforming it from a time domain to the frequency domain.

3. A method according to claim 2, wherein said derivative of the representation of said signal in the frequency domain is a derivative of the Fourier transform of the signal.

4. A method according to claim 1, further comprising deriving a power spectral density from the received signal, wherein said derivative of the representation of the signal in the frequency domain is a derivative of the power spectral density of the signal.

5. A method according to claim 1, further comprising:
applying a Fourier transform on the received signal for transforming it from a time domain to the frequency domain; and
deriving a power spectral density from the Fourier transform of the received signal, wherein said derivative of the representation of the signal in the frequency domain is a derivative of the power spectral density of the signal.

6. A method according to claim 1, wherein estimating the at least one resonant frequency of the bolted joint comprises identifying a peak value of said derivative, such as a maximum absolute value of said derivative.

7. A method according to claim 6, wherein a frequency associated with that peak value is estimated as the resonant frequency of the bolted joint.

8. A method according to claim 1, wherein the impact is generated by a tightening tool, which is the tightening tool applying the clamping force to the bolted joint, or by a device external to such tightening tool.

9. A method according to claim 8, wherein the tightening tool is arranged to deliver a tightening torque in a pulsed manner, and wherein the impact is one of the torque pulses generated by the tool.

10. A method according to claim 1, wherein the estimated clamping force is derived from a look-up table or a function correlating resonant frequency with clamping force.

11. A method according to claim 1, wherein the method is performed during a tightening operation performed by a tightening tool.

12. A control device for estimating a clamping force applied to a bolted joint, said control device configured to:
receive a signal representing a vibration excited by impacting the bolted joint;
estimate at least one resonant frequency of the bolted joint based on a derivative of a representation of said signal in a frequency domain; and
estimate the clamping force applied to the bolted joint based on the estimated at least one resonant frequency.

13. A system comprising:
a tightening tool adapted to apply a clamping force to a bolted joint; and
a control device for estimating the clamping force applied to the bolted joint, said control device configured to:
receive a signal representing a vibration excited by impacting the bolted joint;
estimate at least one resonant frequency of the bolted joint based on a derivative of a representation of said signal in a frequency domain; and
estimate the clamping force applied to the bolted joint based on the estimated at least one resonant frequency.

14. A computer program comprising instructions stored on a non-transitory computer-readable medium, which when the program is executed by a computer, cause the computer to carry out the method as defined in claim 1.

15. (canceled)

16. (canceled)

17. (canceled)
